(19) United States
(12) Patent Application Publication
(10) Pub. No.: US 2003/0193766 A1
(43) Pub. Date: Oct. 16, 2003

(54) Switching Device For Signaling A Binary Information Item

(75) Inventor: Reiner Mantik, Burscheid (DE)

Correspondence Address: FORD GLOBAL TECHNOLOGIES, LLC., SUITE 600 - PARKLANE TOWERS EAST, ONE PARKLANE BLVD., DEARBORN, MI, 48126, US

(73) Assignee: FORD GLOBAL TECHNOLOGIES, LLC, Dearborn, MI (US)

(21) Appl. No.: 10/249,467

(22) Filed: Apr. 11, 2003

(30) Foreign Application Priority Data
Apr. 11, 2002 (EP) 02100365.2

(51) Int. Cl. H02H 3/24

(52) U.S. Cl. 361/92

(57) ABSTRACT

The invention relates to a switching device (9) for an engine controller (7) that permits reliable remote inputting of an item of binary selection information. For this purpose, in the switching device (9) a signal voltage (8) is applied to precisely one of three signal outputs (6a, 6b, 6c) via a switch element (1). The engine controller can then check the signal inputs and interpret the presence of the signal voltage at precisely one signal input as a logic value of the binary information or an intended neutral setting. All of the states in which a signal voltage is not present at precisely one signal input (6a, 6b, 6c) can be detected as faults, as a result of which short circuits and line interruptions can be detected.

### BACKGROUND OF INVENTION

1. Technical Field

The invention relates to a switching device for the reliable, wire-bound signaling of a binary information item, containing a signal voltage terminal and a movable switch element connected thereto. In addition, the invention relates to an electronic engine controller for a motor vehicle, which is configured for the remote inputting of a binary information item.

2. Background of the Invention

Modern motor vehicles have an electronic engine controller which carries out the monitoring and control of a multiplicity of functions in the motor vehicle in a centralized fashion. Examples of such functions are the activation and deactivation of a front-seat passenger's airbag as well as the releasing or engagement of an electric parking brake. In conjunction with these functions, a switching device that is accessible to the driver is provided, it being possible to signal a binary “on/off” information item to the engine controller over respective connecting lines through the activation of the switching device. As the abovementioned examples show, there is a whole series of motor vehicle functions with a high degree of relevance for safety. For this reason, faults in the transmission path from the switching device that is assigned to the driver to the engine controller have to be ruled out with a high degree of probability so that inputs by the driver cannot be incorrectly interpreted by the engine controller and lead to undesired effects.

The simplest way of transmitting a binary information item to the engine controller from a remote location in a wire-bound fashion takes the form of a switch that interrupts or closes the electrical line to the engine controller depending on the position. If this line is connected at one end to a signal voltage, for example to a ground potential, the input of the engine controller may be connected to the signal voltage depending on the position of the switch; these two states then representing two logic values of the binary information item to be transmitted. However, such a switching device is extremely unreliable, as an interruption in the line due to a fault cannot be distinguished from intentional opening of the switch. In addition, it is possible, for example as a result of the ingress of water into the switching device, for a short circuit to occur which would be incorrectly interpreted as the switch closing.

Some of the above problems are avoided by means of a switching device in which the switch is bypassed by a resistor. The opening and closing of the switch thus changes only the overall resistance between the input of the engine controller and the signal voltage terminal of the switching device. In this arrangement, it is possible to distinguish an interruption in the line from the opening of the switch as the former does not lead to an infinitely high resistance. However, there is still the problem of detecting a short circuit in the switching device.

Against this background, one object of the present invention was to make available a switching device and an electronic engine controller that can be coupled thereto, that switching device and engine controller provide a high degree of reliability when remotely inputting a binary information item.

### SUMMARY OF INVENTION

The present invention provides a switching device for signaling of a binary information item.

In one aspect of the invention, a switching device for signaling a binary information item is disclosed. The switching device comprises a signal voltage terminal. The switching device further comprises a movable switching element operatively coupled to the signal voltage terminal. Additionally, the switching device comprises at least three signal output connections, wherein the movable switching element is capable of coupling the signal voltage terminal to each of the at least three signal output connections.

In another aspect of the invention, the switching device described above further comprises an electronic evaluation system. The electronic evaluation system is capable of associating a logic state based on which of the at least three signal output connections is coupled to the signal voltage terminal.

One advantage of the invention is that it provides a high degree of reliability when remotely inputting a binary information item. Another advantage of the invention is that fault conditions are easily determined and distinguished from non-fault operating conditions.

Other advantages and features of the present invention will become apparent when viewed in light of the detailed description of the preferred embodiment when taken in conjunction with the attached drawings and appended claims.

### BRIEF DESCRIPTION OF DRAWINGS

FIG. 1 is a schematic view of the coupling of a switching device according to the invention.

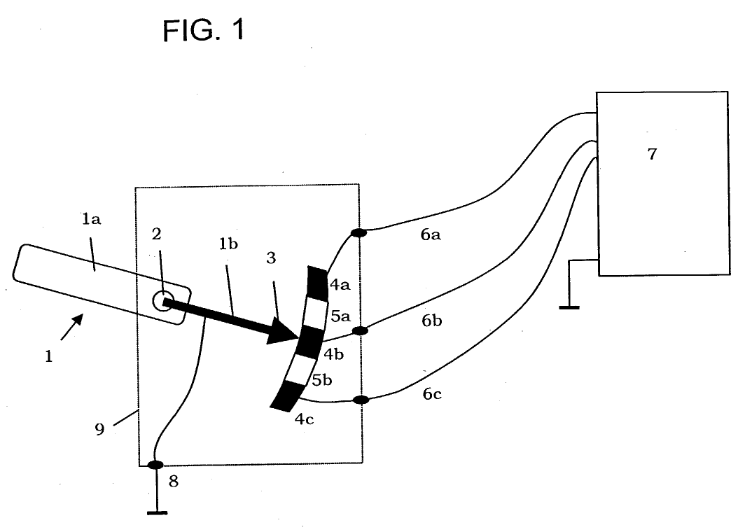

### DETAILED DESCRIPTION

The switching device for the reliable, wire-bound signaling of a binary “on/off” information item contains a signal voltage terminal which can be connected to a source for a predetermined signal voltage as well as a movable switch element which is electrically connected to the signal voltage terminal. The switching device has three signal outputs, each one of which can be electrically connected to the signal voltage terminal via the switch element depending on the position of the switch element.

Accordingly, the switching device makes it possible for the signal voltage that is fed to one signal voltage terminal to be optionally applied to precisely one of three signal outputs. This permits an unambiguous interpretation of the switch position at any time, the presence of the signal voltage at a first or second signal output representing the two logic values (“true/false”) of the binary information item and the presence of the signal voltage at the third signal input being also able to indicate a neutral position of the switch element, in which position no definite value of the binary information is predefined. This neutral position which can be selected and evaluated explicitly makes it possible to distinguish the intentional absence of a selection from an absence which is unintentional or due to a fault and which is present, for example, if the switch element does not have contact with any of the signal outputs and/or there is an interruption in the lines. A further advantage of the switching device is that incorrect behavior cannot occur as a result of a short circuit. If, for example, a further signal output is connected to the signal voltage as a result of a short circuit, there would no longer be only precisely one of the three signal outputs at the level of the signal voltage, as a result of which it would be possible to detect the fault. Furthermore, the switching device is protected from a fault due to a line interruption as such a line interruption would lead to an absence of the signal voltage at all three signal outputs, which would in turn represent a state which can be detected as being faulty.

According to one embodiment of the switching device, the switch element is mounted in a pivoting fashion on an axis and has a slider that slides along contacts which are connected to the signal outputs. In this embodiment of the switching device, the slider can optionally be connected to, in each case, one of the contacts by turning or pivoting the switch element, and as a result the signal voltage that is present at the switch element can be applied to the respective signal output. In a comparatively simple structural configuration, such a switching device ensures that only precisely one of the signal outputs can be connected to a signal voltage at any time.

In the configuration mentioned above, the contacts connected to the signal outputs are preferably separated from one another by electrical insulating faces. During its movement, the slider of the switch element thus comes alternately into contact with contacts and with insulating faces so that it is ensured, given correspondingly large dimensions of the insulating faces, that the slider is not simultaneously in contact with two contacts at any time. This ensures that the signal voltage can be present at a maximum of one signal output at any time.

According to one preferred embodiment of the switching device, it is configured in such a way that the switch element is in a mechanically stable position only when contact is made with a signal output. Intermediate positions in which the switch element connects the signal voltage to none of the signal outputs are therefore mechanically unstable so that the switch element automatically leaves these positions again within a very short time. This ensures that undefined states in which the signal voltage is not present at any of the signal outputs are transient.

The invention also relates to an electronic engine controller for a motor vehicle that is configured for the remote inputting of at least one binary information item. The engine controller can be embodied here in particular as a microcomputer. The engine controller contains three signal inputs which are connected to an electronic evaluation system within the engine controller, the electronic evaluation system being configured in such a way that it interprets the presence of a signal voltage at each one of the signal outputs as inputting of the first or of the second logic value of the information, or as neutral inputting, and it interprets all other voltage states of the signal inputs as faults.

A binary information item can be transmitted to such an engine controller with a high degree of immunity to faults as the two possible logic values of the information (“true/false”, “on/off” etc.) are indicated by means of a separate signal input in each case. Furthermore, by means of the third signal input it is possible to indicate that no selection is made intentionally, i.e., that no signal voltage is present at the two other signal inputs that represent the logic information. This permits a distinction to be made between selective absence of inputting of information and absence due to a fault, for example due to a line interruption. Furthermore, the engine controller can also detect fault situations in which a signal voltage is present at more than precisely one signal input. Such fault states may arise, for example, due to short circuits. They are detected by the electronic evaluation system so that incorrect behavior of the engine controller can be prevented.

The engine controller that is described above can be coupled in particular to a switching device of the type mentioned above as this switching device has the assignment of the signal outputs which matches the evaluation behavior of the engine controller.

According to one embodiment of the electronic engine controller, it is configured in such a way that it interprets the absence of a signal voltage at all three signal inputs as a fault only if this absence lasts for longer than a predefined time period. Such a waiting time takes into account the fact that when the signal assignment changes, undefined intermediate states, in which for example a signal voltage may be present simultaneously at no signal input or at a plurality of the signal inputs, may frequently occur due to the switching equipment.

The binary information item which is transmitted to the engine controller by means of remote inputting can signal, in particular, the instruction to open or close an electric parking brake, or the deactivation of an airbag. These are functions in which a transmission of information that has been subject to faults should be ruled out with the highest possible degree of probability. This is possible with the engine controller according to the invention.

The invention is explained below by way of example with reference to the figure. As explained above, in the field of automatic engineering there is a need for a switching device 9 which is to be activated by the driver and which can be used to transmit a binary information item to a central engine controller 7 with a high degree of reliability. In particular, the switch should be protected against all simple failure modes in accordance with FMEA (failure mode and effect analysis). In addition, the switch should have an immediate reaction to activation, a static switching signal and low manufacturing costs with respect to mass production.

The switching device 9 illustrated in the figure is compatible with these requirements. The switching device is composed of a switch element 1 which can be pivoted about an axis 2 and which has an insulated handle 1a that can be activated by the driver and an electrically conductive section 1b. A slider 3, which can slide along a curved contact path when the switch element 1 is pivoted about the axis 2, is arranged at the end of the electrically conductive section 1b. The conductive section 1b is also connected via a line to a signal voltage input 8 that is connected to the ground potential in the switched state of the switching device 9.

Along the curved movement path of the slider 3, a first contact 4a, a first insulating region Sa, a second contact 4b, a second insulating region 5b, and a third contact 4c are arranged in an alternating sequence. The three aforesaid contacts 4a-c are connected to corresponding signal outputs 6a-c of the switching device 9. In the wired state, these signal outputs are connected one to one to corresponding signal inputs on an engine controller 7.

The engine controller 7 which is embodied as a microcomputer comprises an electronic evaluation system that interprets the states prevailing at the three signal inputs 6a-c as follows (a “1” stands for a state in which the signal voltage is present at the respective signal input):

[t1]

The advantage of the system represented is that each individual fault (short circuit, line interruption) either has no disruptive effect at all or leads to a state that can be detected as invalid by the engine controller 7.

During the pivoting movement of the switch element 1, the slider 3 leaves a contact and moves over an insulating region. For this time period, a faulty pattern (0,0,0), which could cause the engine controller to diagnose a fault, is present at the signal inputs 6a-c. For this reason, a spring force mechanism is preferably provided in the switching device 9, which spring force mechanism keeps the time for which the slider 3 is on the insulating regions 5a, 5b below a specific maximum value, which does not permit the driver to move the switch element 1 into an intermediate position for a relatively long time period. If the aforesaid time period is selected in such a way that it is far below the typical values between two activations of the switching device 9, the engine controller 7 can easily distinguish between a brief, transient interruption during the normal operation of the switch and a permanent fault, e.g., a line break.

A typical application of the system described is the remote inputting of a “release/engage” instruction for an electric parking brake.

While particular embodiments of the invention have been shown and described, numerous variations and alternate embodiments will occur to those skilled in the art. Accordingly, it is intended that the invention be limited only in terms of the appended claims.

What is claimed is:

1. A switching device for signaling a binary information item comprising:
a signal voltage terminal;
a movable switching element operatively coupled to said signal voltage terminal; and
at least three signal output connections, wherein said movable switching element is capable of coupling said signal voltage terminal to each of said at least three signal output connections.

2. The switching device of claim 1, wherein said movable switching element is always coupled to one of said at least three signal output connections in a stable position.

3. The switching device of claim 2, wherein said movable switching element is guided into a stable position by a physical element.

4. The switching device of claim 3, wherein said physical element comprises a spring.

5. The switching device of claim 1, further comprising an electronic evaluation system, said electronic evaluation system being capable of determining which of said at least three signal output connections is coupled to said signal voltage terminal.

6. The switching device of claim 5, wherein said electronic evaluation system determines a logic state based on which of said at least three signal output connections is coupled to said signal voltage terminal.

7. The switching device of claim 6, wherein said electronic evaluation system determines a fault when said signal voltage terminal is not coupled to one of said at least three signal output connections for at least a predetermined time period.

8. The switching device of claim 6, wherein said electronic evaluation system determines a fault when said signal voltage terminal is coupled to more than one of said at least three signal output connections for at least a predetermined time period.

9. The device of claim 1, wherein said movable switching element comprises a slider, said slider being capable of sliding in order to connect said signal voltage terminal to each of said at least three signal output connections.
